(19) United States
(12) Patent Application Publication
(10) Pub. No.: US 2007/0078223 A1
(43) Pub. Date: Apr. 5, 2007

(54) Compositions and structures having tailored oxygen transmission

(76) Inventors: John Chu Chen, Hockessin, DE (US); Donna Lynn Visioli, Lower Gwynedd, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/525,744

(22) Filed: Sep. 22, 2006

Related U.S. Application Data
(60) Provisional application No. 60/722,227, filed on Sep. 30, 2005.
(60) Provisional application No. 60/838,465, filed on Aug. 17, 2006.

(51) Int. Cl. C08F 8/00

(52) U.S. Cl. 525/191

(57) ABSTRACT

Disclosed are structures comprising blends of ethylene containing polymers and highly neutralized ethylene acid copolymers and organic acids that provide tailored oxygen permeability values (OPV). Such structures have improved oxygen permeability and desirable water vapor transmission, formability, and structural strength and are useful in wrapping food products requiring breathable films such as case ready meat, fish, sausage, fresh produce, and the like.

### CROSS-REFERENCE TO RELATED APPLICATIONS

This application claims the benefit of U.S. Provisional Application No. 60/722,227, filed Sep. 30, 2005 and U.S. Provisional Application No. 60/838,465, filed Aug. 17, 2006.

### FIELD OF THE INVENTION

This invention relates to gas permeable structures suitable for use in food packaging. This invention particularly relates to improved packaging structures for perishable food products.

### BACKGROUND OF THE INVENTION

Perishable food products are subject to contamination when exposed to microbial organisms such as bacteria, molds and the like. Contamination can result in accelerated spoilage, toxin formation and other harmful effects. Packaging such perishable goods in gas impermeable materials such as foil, coated paperboard and oxygen barrier films can provide a barrier to microbial contamination. However, it may also be desirable to package perishable goods, particularly fresh food items that respire, in packages that are permeable to certain gases such as oxygen and/or carbon dioxide. To add to the complexity of packaging perishable foods, it is also desirable to control the moisture level in the food.

Oxygen-permeable films are desirable because they prevent growth of anaerobic organisms such as C. botulinum, which produces a potent toxin that is the causative agent of botulism, from contaminating a food item while retaining moisture within the food item. The films also allow ingress of oxygen in packaging for fresh meat which improves its appearance while retaining moisture.

When packaging fresh produce, it is often desirable to control oxygen and water vapor levels so that the produce retains its desired crispness. Produce generally requires a high water vapor barrier to avoid dehydration and prevent wilting, but a lower barrier to oxygen and carbon dioxide because produce continues to respire after it is packaged, so it produces carbon dioxide and consumes oxygen. Because respiration rates differ for varying types of produce and with storage temperature, the amount of permeation that is optimum depends on the species of produce. Similarly, natural cheeses that are ripened by the action of microbes rubbed on their surfaces, such as Brie and Camembert, require controlled ingress of oxygen and moisture to develop texture and flavor. Thus it is desirable to prepare packages that have gas permeability and moisture barrier properties tailored for the freshness requirements of the perishable food items to be packaged. One method to address this need makes use of laminated film structures that are microperforated.

It is also desirable that packages are prepared using materials having physical properties suitable for protecting the produce in various packaging forms. For example, packages may require packaging materials that are capable of being flexible, semi-rigid, or rigid while providing desirable gas permeation properties.

U.S. Pat. App. Pub. 2003/0198715 A1 and copending U.S. patent application Ser. No. 11/184,143 disclose films and packages of highly neutralized blends of organic acids and ethylene acid copolymers having good oxygen permeability. These references disclose compositions having useful properties but it is desirable to have compositions available that provide a more effective means for tailoring and balancing oxygen permeability in combination with optical and mechanical properties to produce packaging materials designed for specific food.

### SUMMARY OF THE INVENTION

In one aspect, the present invention is a composition consisting essentially of
A. from about 5 to about 60 weight percent, based on the total weight of the composition, of at least one polyolefin selected from the group consisting of a) ethylene homopolymers, b) copolymers of ethylene and an alpha-olefin having three or more carbon atoms and c) mixtures thereof, wherein said polyolefin is substantially free of carboxylic acid, ester and anhydride groups; and
B. from about 40 to about 95 weight percent, based on the total weight of the composition, of a combination consisting essentially of
   1. a polar compound component selected from the group consisting of a) aliphatic organic carboxylic acids having fewer than 36 carbon atoms, b) salts of said acids and c) mixtures thereof;
   2. a polar copolymer component selected from the group consisting of a) ethylene acid copolymers having copolymerized units of ethylene, at least one C₃ to C₈ α,β-ethylenically unsaturated carboxylic acid, and optionally a comonomer selected from the group consisting of alkyl acrylates and alkyl methacrylates, wherein said alkyl groups have from 1 to 8 carbon atoms, b) ionomers of said ethylene acid copolymers, and c) mixtures thereof, wherein the weight percentage of copolymerized units of said unsaturated carboxylic acid in said ethylene acid copolymer is from about 3 to about 35 wt. %, based on the weight of said ethylene acid copolymer; and
   3. at least one ethylene unsaturated ester copolymer having copolymerized units of ethylene and a comonomer selected from the group consisting of vinyl acetate, alkyl acrylates and alkyl methacrylates,
      wherein greater than 70% of the total combined carboxylic acid moieties of said polar compound component and said polar ethylene acid copolymer component are neutralized to the corresponding alkaline earth metal carboxylate salts.

Preferably, components B1, B2 and B3 of the above-described composition are combined prior to mixing with component A. Also preferably, the combination of components B1, B2 and B3 is from 60 to 95 weight %, more preferably from 65 to 90 weight %, based on the total weight of the composition.

These polymer blend compositions are solid compositions and may be used to provide structures having a combination of tailored oxygen and moisture barrier properties, good formability and structural strength and can be useful for containing food products such as case ready meat, fish, sausage, cheese, fresh produce, and the like that require breathable package structures. Thus, the present invention also provides a monolithic structure consisting essentially of the above-described composition. The present invention further provides a multilayered structure comprising at least one layer obtained from the above-described composition and shaped articles comprising the composition.

In another aspect, this invention provides a package comprising the above-described composition, including packages further comprising a perishable foodstuff.

### DETAILED DESCRIPTION OF THE INVENTION

Unless stated otherwise, all percentages, parts and ratios are by weight. Further, when an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range. When a component is indicated as present in a range that has a lower limit of 0, such component is an optional component (i.e., it may or may not be present).

The term “consisting essentially of”, as used herein when referring to a composition, means that the composition includes the recited components and those that do not materially affect the basic and novel characteristics of the specified composition. The term “(meth)acrylic”, as used herein, alone or in derivative form, is a shorthand notation for compounds having either acrylic functionality, methacrylic functionality or a mixture of compounds of both types, and generally indicates that either or both types of compounds are used or can be useful. For example, “alkyl(meth)acrylate” as used herein generically refers to an alkyl acrylate, an alkyl methacrylate, or to a mixture thereof.

Perishable goods that can be packaged according to this invention include meat, fish, poultry, cheese or fresh produce, including vegetables and/or fruit, as well as other perishable goods.

Polyolefins suitable for use in the compositions of the invention include polyethylene homopolymers and copolymers of ethylene and an alpha-olefin having three or more carbon atoms. Such polymers include branched polyethylenes, such as low density polyethylenes (LDPE), linear low density polyethylenes (LLDPE), ultra low density polyethylenes, very low density polyethylenes, metallocene polyethylenes (mPE), ethylene propylene copolymers, and copolymers of ethylene, propylene and a diene monomer. These latter copolymers are commonly referred to in the art as EPDM copolymers. EPDMs include terpolymers as well as higher order copolymers such as tetrapolymers. Tetrapolymers include, for example, copolymers of ethylene, propylene, 1,4-hexadiene and ethylidene norbornene. The mPE are meant to include those polyethylenes that are prepared in the presence of metallocene catalysts as well those prepared in the presence of constrained geometry catalysts and single site catalysts.

Polyethylene homopolymers and copolymers useful in the compositions described herein can be prepared by a variety of methods. Examples of such processes include, but are not limited to, the well-known Ziegler-Natta catalyst polymerization (see for example U.S. Pat. No. 4,076,698 and U.S. Pat. No. 3,645,992), metallocene catalyzed polymerization, Versipol™ single-site catalyst polymerization and free radical polymerization. As used herein, the term metallocene catalyzed polymerization includes polymerization processes that involve the use of metallocene catalysts as well as those processes that involve use of constrained geometry and single-site catalysts. Polymerization can be conducted as a solution phase process, a gas phase process, and the like.

The densities of polyethylenes suitable for use in the first component of the compositions of the present invention range from about 0.850 g/cc to about 0.970 g/cc, preferably from about 0.850 g/cc to about 0.930 g/cc, more preferably from about 0.850 g/cc to about 0.910 g/cc. Linear polyethylenes useful in the compositions of the invention can incorporate copolymerized units of alpha-olefin comonomers such as butene, hexene or octene to provide preferred copolymers within the density ranges so described. For example, a copolymer useful as the polyolefin component can comprise a major portion or percentage by weight of copolymerized units of ethylene and a minor portion or percentage by weight of copolymerized units of at least one other alpha-olefin. Suitable alpha-olefins can be selected from the group consisting of alpha-olefins having at least three carbon atoms, preferably from 3 to 20 carbon atoms. These comonomers are present as copolymerized units in an amount of up to about 20 weight % of the copolymer. Preferred alpha-olefins include propylene, 1-butene, 1-hexene, 4-methyl-1-pentene, 1-octene, 1-decene, 1-tetradecene and 1-octadecene. Copolymers can be obtained by polymerization of ethylene with two or more alpha-olefins, preferably including propylene, 1-butene, 1-octene and 4-methyl-1-pentene. Also contemplated for use herein as the polyolefin component of the compositions of the invention are blends of two or more of these ethylene alpha-olefin copolymers as well as mixtures of an ethylene homopolymer and one of the suitable ethylene alpha-olefin copolymers. Ethylene copolymers having small amounts of a diolefin component such as butadiene, norbornadiene, hexadiene and isoprene are also generally suitable for preparation of blended compositions.

Thus, when the polyolefin is a copolymer it may be an ethylene/propylene elastomer that has double bonds. Such copolymers include EPDMs that are terpolymers, tetrapolymers or higher order copolymers formed by copolymerization of ethylene, propylene, dienes and optionally other olefin comonomers.

Ethylene copolymers suitable for use as the polyolefin component of the compositions of the invention are commercially available. For example, Exact® 3035 plastomer, available from ExxonMobil Corp. and Engage® 8450 polyolefin, available from The Dow Chemical Co. may be used. Without being held to theory, metallocene polyethylene, that is polyethylene prepared in the presence of metallocene catalysts, including constrained geometry catalysts and single-site catalysts (mPE) can be of note in the practice of the present invention because of the substantially linear structure and narrow molecular weight distribution of such polymers. Metallocene catalysis technology includes processes capable of making low density polyethylene having high flexibility and low crystallinity with good oxygen permeability. This latter property is particularly desirable in the polyolefin that forms the first component of the compositions of the invention. Metallocene technology and metallocene catalysis are described in, for example, U.S. Pat. Nos. 5,272,236; 5,278,272, 5,507,475, 5,264,405, and 5,240,894.

The mPE employed in the present invention can be any polyethylene that is prepared in the presence of the metallocene catalysts described above, including constrained geometry catalysts and single-site catalysts generally known in the art, provided the oxygen permeability of the polyethylene is sufficiently high to afford the requisite breathability necessary for the intended applications of interest. Preferably the mPE has a density of less than 0.91 g/cc, wherein the normalized oxygen permeation value (OPV) at 23° C. and 50% relative humidity will be greater than about 12,400 cc-mil/m²·day. Such mPE can optionally be blended with other polyolefins of low crystallinity as well as amorphous polyethylenes to form the polyolefin that is the first component of the compositions of the invention, provided the composition retains significantly high oxygen permeability. By significantly high oxygen permeability is meant that that its OPV is greater than about 8,000 cc-mil/m² day•as measured according to ASTM D 3985-95. Suitable amorphous polyethylenes for use in preparing such blends include low density polyethylene, linear low density polyethylene, other mPEs and the like.

The polyolefins suitable for use as the first component of the compositions of the invention are non-polar olefin polymers formed of copolymerized units of olefin monomers. They are substantially free of carboxylic acid groups, carboxylic acid ester groups and carboxylic acid anhydride groups. That is, they contain less than about 0.5 wt. %, preferably less than 0.1 wt. %, most preferably less than 0.01 wt. %, of such groups, based on the weight of the polymer. Polyolefins that form the first component of the compositions of the invention are substantially free of copolymerized units of such monomers. They are also substantially free of carboxylic acid groups, carboxylic acid ester groups and carboxylic acid anhydride groups that have been introduced into the polyolefin by subsequent chemical reaction, such as by grafting with anhydrides.

The second component of the compositions of the present invention consists essentially of a combination of three compositions that contain carbonyl groups. The first of these components, B1, is a polar compound component that is selected form the group consisting of aliphatic organic acids, salts of the acids and mixtures thereof. The second component, B2, is a polar copolymer component selected from the group consisting of ethylene acid copolymers, ionomers of the copolymers and mixtures thereof. The third component, B3, is a copolymer of ethylene and an unsaturated ester. The acid moieties of B1 and B2 are neutralized in an amount of greater than 70% to the corresponding alkaline earth metal salts. That is, the total combined carboxylic acid groups of the B1 and B2 components are neutralized to a degree of greater than 70% to the corresponding alkaline earth metal salts.

The organic acids, salts or mixtures thereof employed as component B1 in the compositions of the present invention are aliphatic, mono-functional organic carboxylic acids or their salts, particularly those having fewer than 36 carbon atoms. The acids may be saturated or unsaturated, and may include multiple sites of unsaturation. If salts of the acids are employed, the organic acid salts will be alkaline earth metal salts, preferably magnesium or calcium salts. However other salts can be utilized in combination with the component B1 salts so long as the oxygen permeability of the composition consisting essentially of the polyolefin component A and the combined B1, B2 and B3 compositions is maintained at an effective level. That is, so long as a film of 1 mil thickness of the composition of the invention maintains an oxygen permeability value of at least 8000 mil-cm/m²-day measured in accordance with ASTM D 3985-95, a mixture of the component B1 salts and other salts may be used. Other salts that can be utilized include alkali metal salts, such as potassium salts, for example.

While it may be useful for the organic carboxylic acids and salts to have a low volatility for purposes of melt blending or otherwise mixing with one or more of the other materials that make up the second component of the compositions of the invention, volatility is not a limiting factor. As such, organic acids with lower carbon content can be used in the practice of the present invention. It can be preferred, however, that the organic acid or salt be non-volatile and non-migratory. By non-volatile it is meant that the acids or salts do not volatilize in the range of temperatures useful for melt blending with component B2, i.e. the ethylene acid copolymers, ionomers or mixtures thereof. Typical temperatures for melt blending range from 150° C. to 250° C. By non-migratory it is meant that the organic acid does not bloom to the surface of the ethylene acid copolymer or composition of the invention under normal storage conditions at ambient temperatures.

The acids and/or their salts effectively modify the ionic morphology and/or reduce the level of crystallinity of the component B2 ethylene acid copolymers and copolymer ionomers of the present invention. Particularly useful organic acids include acids having from four to 34 carbon atoms. More preferred are acids having six to twenty-six carbon atoms, and even more preferred are acids having six to twenty-two carbon atoms. Organic acids useful in the practice of the present invention include but are not limited to caproic acid, caprylic acid, capric acid, palmitic acid, lauric acid, stearic acid, isostearic acid, behenic acid, erucic acid, oleic acid, and linoleic acid and their mixtures. More preferably, the naturally derived organic fatty acids such as palmitic, stearic, oleic, behenic, and mixtures thereof can be conveniently employed. Saturated organic acids can be preferred for the purpose of reducing organoleptic properties of structures made from the compositions of the invention. Such structures can include films and other packaging materials. Stearic acid can be preferred.

Saturated, branched organic acids can be particularly preferred to provide greater oxygen permeability. Of the branched saturated acids, isostearic acid is particularly preferred. One of ordinary skill can appreciate that mixtures of any of the organic acids contemplated herein can provide properties that can be expected or anticipated from the properties of the individual organic acid components.

Component B2 of the compositions of the present invention is an ethylene acid copolymer, ionomer thereof or a mixture of such copolymers and ionomers. Acid copolymers used in the present invention are preferably prepared by copolymerization of an acid comonomer, rather than by subsequent chemical treatment of an ethylene copolymer to introduce carboxyl functionality. The acid copolymers are copolymers of ethylene and a C₃-C₈ α,β-ethylenically unsaturated carboxylic acid. Acrylic and methacrylic acids are preferred comonomers. One particularly useful class of ethylene acid copolymers includes those ethylene acid copolymers that contain an additional monomer that can disrupt the crystallinity of the copolymer.

In general, the most useful ethylene acid copolymers can be described as E/X/Y copolymers where E is ethylene, X is the α,β-ethylenically unsaturated carboxylic acid, and Y is a third comonomer. That is, the polymers have copolymerized units of ethylene, the α,β-ethylenically unsaturated carboxylic acid and optionally, a third monomer. The α,β-ethylenically unsaturated carboxylic acid is present in an amount of from 3 to 35, preferably from 4 to 25, more preferably from 5 to 20 weight % of the ethylene acid copolymer. Y, the third comonomer, is an optional comonomer present in amounts of from 0 to 35 weight %, alternatively from 1 to 35 weight, more preferably from 4 to 25 weight % of the ethylene acid copolymer, based on the weight of the ethylene acid copolymer. Notable are ethylene α,β-ethylenically unsaturated carboxylic acid dipolymers, i.e. E/X dipolymers. These are equivalent to E/X/Y copolymers wherein copolymerized units of Y are not present in the copolymer.

Suitable third comonomers are selected from the group consisting of alkyl acrylates and alkyl methacrylates, wherein the alkyl groups have from 1 to 8 carbon atoms. Preferred alkyl acrylates and alkyl methacrylates are those wherein the alkyl groups have from 1 to 4 carbon atoms, and more preferred are those wherein the alkyl groups have from 3 to 4 carbon atoms. Additionally, the copolymers may be higher order copolymers having more than one alkyl acrylate or alkyl methacrylate comonomer of this type.

Ethylene acid copolymers having high levels of α,β-ethylenically unsaturated carboxylic acid are difficult to prepare in continuous reactors because of monomer-polymer phase separation. This difficulty can be avoided by use of “co-solvent technology” as described in U.S. Pat. No. 5,028,674 or by employing somewhat higher pressures than those at which copolymers with lower acid levels can be prepared.

Specific ethylene acid copolymers suitable for use in the compositions of the invention include, but are not limited to ethylene/(meth)acrylic acid dipolymers; ethylene/(meth)acrylic acid/n-butyl(meth)acrylate terpolymers; ethylene/(meth)acrylic acid/iso-butyl(meth)acrylate terpolymers; ethylene/(meth)acrylic acid/methyl(meth)acrylate terpolymers and ethylene/(meth)acrylic acid/ethyl(meth)acrylate terpolymers.

Ethylene acid copolymers that are at least partially neutralized to the corresponding salts are members of the class generally known as ionomers. Ionomers useful in the compositions of the invention are obtained from the ethylene acid copolymers described above by neutralization, generally accomplished by melt extrusion in the presence of a stoichiometric amount of neutralizing agent, such as Mg(OH)₂, for example. The ionomers include partially neutralized ethylene acid copolymers, particularly ethylene/(meth)acrylic acid copolymers. The ionomers may be neutralized to any level that does not result in an intractable (that is, not melt processible) polymer without useful physical properties. The ionomers useful herein comprise alkaline earth metal-neutralized ionomers. Calcium and magnesium ionomeric compositions are preferred for high oxygen permeability and moisture barrier properties, but as described above, ionomers having other cations may be present, so long as the concentration of these other ionomers does not rise to the level wherein the oxygen permeability of the composition is decreased to below 8000 cc-mil/m²-day. Other cations that can be present in limited quantities and which are useful in preparing the oxygen permeable blends of this invention include lithium, sodium, or zinc, or combinations of two or more of these cations. In some instances, use of calcium can be preferred over the use of magnesium, or vice versa. One of ordinary skill in the art can determine what is a preferable composition for a given circumstance.

It is preferred that the B1 and B2 components of the compositions of the invention are present in a particular ratio. That is, preferably the total component B1 compositions, i.e. the total B1 acids or salts thereof or mixtures thereof, are present in an amount of from about 3 to about 55 wt. %, preferably, from about 5 to about 25 wt. %, based on the total combined weight of components B1 and B2, where B2 means the total ethylene acid copolymers, ionomers or mixtures thereof.

An important aspect of the present invention is that the total combined carboxylic acid groups, i.e. carboxylic acid moieties, of the polar compound component B1 and the polar ethylene acid component B2 are neutralized to the corresponding alkaline earth metal carboxylate salts, particularly the magnesium and calcium salts, in an amount greater than 70%. High levels of neutralization, above 70%, can be obtained by adding a stoichiometric amount of a cation source calculated to neutralize the target amount of total carboxylic acid moieties in the acid copolymer and organic acid(s) in the blend (hereinafter referred to as “% nominal neutralization” or “nominally neutralized”). Thus, for example, sufficient calcium or magnesium cations or mixtures thereof are made available in the blend so that, in aggregate, the indicated level of nominal neutralization is achieved. Preferably the % nominal neutralization will be greater than about 80%, more preferably greater than about 90%, and even more preferably from about 91% to about 100%.

It is often useful to obtain the necessary degree of neutralization, i.e. salt formation, in a step wherein blends of B1 and B2 components are neutralized together or merely mixed together. For example, B1 and B2 components may be in the form of carboxylic acids, carboxylic acid salts, (i.e. carboxylate salts) ethylene acid copolymers, ethylene acid copolymer ionomers or mixtures thereof prior to treatment with a source of neutralizing cations. An ionomer having a low level of neutralization can be further neutralized using such a treatment. Thus, compositions of the invention also include B1 and B2 components where the total level of neutralized carboxylic acid moieties is less than 70%, providing that a sufficient amount of neutralizing agent, such as metal oxide, metal hydroxide or other neutralizing agent, is present to provide a nominal neutralization of greater than 70% of the total acid moieties present. For example, an ionic compound that is a source of cations, such as magnesium oxide, calcium oxide, magnesium hydroxide, calcium hydroxide or mixtures thereof may be blended with a fatty acid and an ethylene acid ionomer having less than 70 wt. % neutralization in an amount such that the mixture is converted to a composition wherein greater than 70% of the carboxylic acid moieties of the fatty acid and the carboxylic acid groups of the ethylene acid copolymer ionomer present are neutralized to the corresponding carboxylate salts. Thus, a stoichiometric amount of cations will be present that, in aggregate, is sufficient to neutralize greater than 70% of the carboxyl groups present in the combined B1 and B2 species to form carboxylate salts thereof. Conversely, an ionomer having a high level of neutralization can be converted to one having a lower level of neutralization as a result of blending with a mixture of unneutralized acid copolymers or acids in an appropriate melt mixing process that accomplishes ion transfer. Mixing methods suitable for the component B compositions will take into account temperature, shear conditions and mixing time and are well-known in the art and are described for example in U.S. Pat. No. 6,777,472.

The ethylene acid copolymer(s) or ionomer(s) can be melt-blended with the organic carboxylic acid(s) or salt(s) by any suitable technique. For example, the solid components can be mixed to obtain a solid phase mixture of the components and the components can then be melt-blended in an extruder. Also, for example, a Werner & Pfleiderer twin-screw extruder can be used to neutralize the acid copolymer and the organic acid concurrently.

Components B1, B2 and mixtures thereof can be neutralized according to the following procedures and any others that will be familiar to those of skill in the art:
(1) melt-blending the component B2 ethylene α,β-ethylenically unsaturated C₃-C₈ carboxylic acid copolymer(s) and/or ionomer(s) thereof with one or more component B1 aliphatic, mono-functional, saturated or unsaturated organic acids having less than 36 carbon atoms or salts of the organic acids, and concurrently or subsequently;
(2) adding a sufficient amount of an alkaline earth metal cation source to increase the level of nominal neutralization to greater than about 70%.

Neutralization of ethylene acid copolymers and organic carboxylic acids in one step is preferred. Neutralization of the acid copolymers can also be accomplished using a diluent during the neutralization process. Care should be taken when neutralizing copolymers of the present invention so that there is no loss of desirable properties or difficulties in processing the copolymers. Neutralization to any level taught or claimed herein or in the prior art, for example in International Publication No. WO 2004/043155 A2 is generally suitable. It has been found that an ethylene acid copolymer blended with organic carboxylic acid(s) can be neutralized to over 80%, preferably 90%, more preferably to about 100% or even to 100% nominal neutralization without losing melt processibility as can occur with acid copolymers, not of this invention, that are neutralized to greater than 80%.

Component B3 of the compositions of the present invention is a copolymer of ethylene and an unsaturated ester. In particular, component B3 is a copolymer having copolymerized units of ethylene and a comonomer selected from the group consisting of vinyl acetate, alkyl acrylates and alkyl methacrylates wherein the polymer contains copolymerized units of at least 2 weight % of the comonomer. Component B3 is thus a substantially different ethylene copolymer from the ethylene copolymers that constitute the first polyolefin component of the compositions of the present invention.

When B3 is an ethylene vinyl acetate copolymer, the percentage of copolymerized vinyl acetate units can vary broadly from 2 percent to as much as 40 weight percent of the total weight of the copolymer or even higher.

The weight percentage of copolymerized vinyl acetate units in the copolymer will preferably be from 2 to 40 weight %, especially from 10 to 40 weight %. The ethylene/vinyl acetate copolymer preferably has a melt flow rate, measured in accordance with ASTM D-1238 at 190° C., of from about 0.1 to about 40 g/10 minutes, 2.16 kg. wt. and especially from about 0.3 to about 30 g/10 minutes, 2.16 kg wt. The ethylene-containing copolymers useful as component B3 in the compositions described herein can be modified by methods well known in the art, including chemical reaction by grafting with an unsaturated carboxylic acid or its derivatives, such as maleic anhydride or maleic acid.

A mixture of two or more different ethylene/vinyl acetate copolymers can be used as component B3 in blends of the present invention in place of a single copolymer as long as the average values for the weight percentage of vinyl acetate comonomer units, based on the total weight of the copolymers, is within the range indicated above. Particularly useful properties may be obtained when two or more properly selected ethylene/vinyl acetate copolymers are used in the compositions of the present invention.

Component B3 may also be an ethylene alkyl acrylate or ethylene alkyl methacrylate copolymer. Alkyl(meth)acrylates suitable for use in the practice of the present invention are selected from alkyl(meth)acrylates having alkyl groups of 1 to 8 carbon atoms. Examples of alkyl acrylates suitable for use herein include, without limitation, methyl acrylate, ethyl acrylate and butyl acrylate.

The relative amount of the alkyl(meth)acrylate comonomer incorporated as copolymerized units into an ethylene/alkyl(meth)acrylate copolymer of the present invention can vary broadly from a few weight percent to as much as 45 weight percent, based on the weight of the copolymer or even higher. Similarly, the alkyl group can be a methyl group or any alkyl group having up to eight carbon atoms. Most preferably, the alkyl group of the alkyl(meth)acrylate comonomer is methyl, ethyl or n-butyl. Preferably, the level of copolymerized units of alkyl(meth)acrylate comonomer in the ethylene/alkyl(meth)acrylate copolymer is within the range of from 5 to 45 weight percent, more preferably from 10 to 35 weight %, still more preferably from 10 to 28 weight %, based on the weight of the copolymer. Mixtures of ethylene/alkyl(meth)acrylate copolymers may also be used, so long as the level of copolymerized units of (meth)acrylate is within the above-described range, based on the total weight of copolymer present.

Ethylene copolymers suitable for use herein can be produced by any process, including processes that involve use of a tubular reactor or an autoclave. Copolymerization processes conducted in an autoclave may be continuous or batch processes. In one such process, disclosed in general in U.S. Pat. No. 5,028,674, ethylene, the alkyl acrylate, and optionally a solvent such as methanol are fed continuously into a stirred autoclave such as the type disclosed in U.S. Pat. No. 2,897,183, together with an initiator. Ethylene/alkyl acrylate copolymers produced using an autoclave process can be obtained commercially, for example from Exxon/Mobil Corp, and/or from Elf AtoChem North America, Inc. Ethylene/alkyl(meth)acrylate copolymers obtained using a tubular reactor process are produced at high pressure and elevated temperature. In a tubular reactor, the inherent consequences of dissimilar reaction kinetics for the respective ethylene and alkyl acrylate comonomers are alleviated or partially compensated for by the intentional introduction of monomers along the reaction flow path within the tubular reactor. Such copolymers can be obtained commercially from E. I. du Pont de Nemours and Company.

The molecular weight and melt index of ethylene/alkyl(meth)acrylate copolymers suitable for use in the practice of the present invention can vary significantly. The specific melt index that is desirable may depend on the balance of properties sought from the blend intended to provide the desired mix of oxygen permeability and structural properties needed for a specific packaging structure.

For the purposes of the present invention, it is contemplated that component B3 can be a mixture of components, including mixtures of various species of a particular copolymer, so long as the intended use of the blend is not compromised. For example, ethylene alkyl(meth)acrylates having various melt indices, or having different alkyl groups, can be utilized as a mixture to fulfill the intended function of component B3 herein.

It is possible to prepare the blends of the invention by melt blending a mixture of components B1 and B2 (i.e. the organic carboxylic acid, acid salt, ethylene acid copolymer and ethylene acid ionomer components) with components B3 and A (i.e. the ethylene unsaturated ester copolymer and polyolefin components). The components may be mixed together in one step, the components can be added sequentially or the components may be added in any order or variation. For example, the organic acid or salt modification, i.e. mixing and neutralization of the component B1 and B2 carboxylic acids, carboxylic acid salts, ethylene acid copolymers or ionomers, can be effected and then the component B3 material can be added to the modified product. An example of this would be mixing and neutralization of component B1 organic carboxylic acid and B2 ethylene acid copolymer or ionomer in a continuous melt mixer, such as a continuous melt extruder, with downstream addition of the B3 component to provide a mixture of components B1, B2, and B3 that can be subsequently mixed with the component A polyolefin of the compositions of the invention. Alternatively, the organic carboxylic acid and ethylene acid copolymer may be neutralized and processed into a form such as pellets. The pellets can be dry blended with pellets of the ethylene ester copolymer, i.e. component B3, and/or the polyolefin copolymer component A. The resulting blend may be melt blended to form a composition of the invention.

Of particular note is a composition consisting essentially of (1) from 55 to 60 weight % of an ethylene methacrylic acid copolymer having 15 weight % copolymerized units of methacrylic acid having a melt index of 60 g/10 minutes (190° C. 2.16 kg weight), as component B2; (2) from 13 to 16 weight % of an ethylene methyl acrylate copolymer having 24 weight % copolymerized units of methyl acrylate having a melt index of 20 g/10 minutes (190° C., 2.16 kg. weight) as component B3; and (3) from 23 to 26 weight % of magnesium stearate as component B1; wherein the combination of (1), (2) and (3) is further neutralized with from 3 to 9 weight % magnesium hydroxide so that the composition has a melt index of from 0.5 to 1 g/10 minutes (190° C., 2.16 kg. weight). This composition can be prepared by feeding components B1, B2 and B3 into an extruder with magnesium hydroxide and melt blending. The resulting blend can be provided in the form of pellets. This composition can be used as a modifier for polyethylene, such as a mPE or a LLDPE.

Optional antioxidant additives can be useful in modifying the organoleptic properties (e.g. reducing odor or taste) of the blends of this invention. The use of antioxidants may be preferred when the organic acid is unsaturated. Antioxidants are available under the trade name Irganox® from Ciba Geigy Inc. Tarrytown, N.Y. For example, phenolic antioxidants such as Irganox® E201 antioxidant or its derivatives may be added to the blend. Irganox® 1010 antioxidant is also suitable for use in this invention.

As previously discussed, one group of compositions of the invention consists essentially of polyolefin component A and polymer component B, which is a combination of components B1, B2 and B3. The first polyolefin component of the composition is present in an amount of from about 5 to about 60 weight percent, based on the total weight percent of the composition. The amount of the combined components B1, B2 and B3 is from about 40 to about 95 weight percent, based on the total weight percent of the composition. Preferably, the first polyolefin component will be present in an amount of from 5 to about 40 weight percent based on the weight of the composition. Other materials may be present so long as these percentages, based on the total weight of the composition, are maintained.

When the components of the composition are within these ranges mechanical properties such as stiffness can be balanced with the oxygen permeability necessary for effective packaging of various types of produce for freshness. For example, packaging film and containers require different levels of stiffness. Depending on its natural form and structure certain food may be more effectively packaged in rigid or flexible containers or films to insure it is protected against damage during transportation and storage, but the proper degree of oxygen permeability is maintained. Similarly, packaging with different optical properties can be desirable for aesthetic reasons.

The compositions of the invention have tailored oxygen permeability and can be used to prepare monolithic or multilayer structures. The compositions of the invention can also be converted to blown films, for example but not limitation, by feeding a combination of polyethylene pellets, pellets of a blend of components B1 and B2 (referred to as an organic acid modified ionomer blend) and pellets of B3, into a blown film machine, melt blending them and extruding them through an annular die according to procedures well known in the art of preparing blown films. Cast films can be prepared by melt blending polyethylene and the organic acid modified ionomer blend and extruding through a slit die according to procedures well known in the art of preparing cast films.

The compositions of the invention may be used to form multilayer structures. Ethylene-containing polymers or ionomers can be employed as additional layers in such multilayer structures with the caveat that mono- or multilayer structures suitable for use in the practice of the present invention should have the requisite strength needed in the projected uses of such structures, in addition to tailored oxygen permeability as described elsewhere in this application.

The oxygen permeability of a multilayer structure is related to the thickness and permeability of each of the layers in the following manner:

$$\frac{1}{{OPV}_{package}} = \frac{{x}_{1}}{{OPV}_{1}} + \frac{{x}_{2}}{{OPV}_{2}} + … \qquad ( 1 )$$

where OPV_{package} is the permeability of the package normalized to 1 mil OPV₁ is the permeability of layer 1, OPV₂ the permeability of layer 1, x₁ is the fraction of the structure thickness that comprises layer 1, and x₂ is the fraction of the structure thickness that comprises layer 2.

By using formula (1) combinations of highly permeable and less permeable materials for various layers can be identified that will achieve the desired permeability requirements of the application, while maintaining desired strength and forming properties.

Various embodiments of the present invention can be envisioned. For example, a multilayer structure having at least one layer consisting essentially of a composition of the invention, i.e. a blend of components A, B1, B2, and B3 (hereinafter a “permeable blend composition”) with at least one other layer comprising another material. The various combinations are not limited by the examples described herein. One of ordinary skill in the art would be able to construct suitable structures from the teachings provided.

A specific embodiment of the invention provides an oxygen permeable multilayer polymeric structure comprising:
(i) at least one polymeric layer consisting essentially of a permeable blend composition of the invention; and
(ii) at least one additional polymeric layer comprising a copolymer of ethylene and vinyl acetate.

Preferably this embodiment comprises three polymeric layers wherein both outer layers comprise the ethylene/vinyl acetate copolymer of (ii) and an interior layer consists essentially of the permeable blend composition of (i).

Another specific embodiment of the invention provides an oxygen permeable multilayer polymeric structure comprising:
(i) at least one polymeric layer consisting essentially of a permeable blend composition of the invention; and
(ii) at least one additional polymeric layer comprising a copolymer of ethylene and an alkyl(meth)acrylate.

Another specific embodiment provides an oxygen permeable multilayer polymeric structure comprising
(i) at least one polymeric layer consisting essentially of a permeable blend composition of the invention; and
(ii) at least one additional polymeric layer comprising a mPE having a density of less than 0.91 g/cc; or a blend of a mPE having a density of less than 0.91 g/cc and a low density polyethylene.

Preferably this embodiment comprises three polymeric layers wherein both outer layers comprise the mPE or mPE blend of (ii) and a middle layer consists essentially of the permeable blend composition of (i).

Still another embodiment provides an oxygen permeable multilayer polymeric structure comprising:
(i) at least one polymeric layer consisting essentially of a permeable blend composition of the invention; and
(ii) at least one polymeric layer comprising an ethylene acid copolymer having copolymerized units of ethylene, at least one C₃ to C₈ α,β-ethylenically unsaturated carboxylic acid, and optionally a comonomer selected from the group consisting of alkyl acrylates and alkyl methacrylates, wherein the alkyl groups have from 1 to 8 carbon atoms, or ionomers of said copolymers, and wherein the weight percentage of copolymerized units of said unsaturated carboxylic acid in said ethylene acid copolymer is from about 3 to about 35 wt. %, based on the weight of said ethylene acid copolymer, and wherein from 0% to 90% of the acid groups are neutralized.

Preferably this embodiment is formed of three polymeric layers wherein both outer layers comprise the composition of (ii) and a middle layer consists essentially of the permeable blend composition of (i).

Additional specific embodiments include films or other structures with at least three different layers, one of which consists essentially of the permeable blend composition of this invention.

Accordingly, a specific embodiment of the invention provides an oxygen permeable multilayer polymeric structure comprising:
(i) at least one polymeric layer consisting essentially of a permeable blend composition of the invention; and
(ii) at least one polymeric layer comprising an ethylene acid copolymer having copolymerized units of ethylene, at least one C₃ to C₈ α,β-ethylenically unsaturated carboxylic acid, and optionally a comonomer selected from the group consisting of alkyl acrylates and alkyl methacrylates, wherein the alkyl groups have from 1 to 8 carbon atoms, or ionomers of said copolymers, wherein the weight percentage of copolymerized units of said unsaturated carboxylic acid in said ethylene acid copolymer is from about 3 to about 35 wt. %, based on the weight of said ethylene acid copolymer; and wherein from about 0% to about 90% of the acid is neutralized; and
(iii) at least one additional polymeric layer comprising a mPE having a density of less than 0.91 g/cc; or a blend of a mPE having a density of less than 0.91 g/cc and a low density polyethylene.

Another specific embodiment of the invention provides an oxygen permeable multilayer polymeric structure comprising:
(i) at least one polymeric layer consisting essentially of a permeable blend composition of the invention; and
(ii) at least one polymeric layer comprising an ethylene acid copolymer having copolymerized units of ethylene, at least one C₃ to C₈ α,β-ethylenically unsaturated carboxylic acid, and optionally a comonomer selected from the group consisting of alkyl acrylates and alkyl methacrylates, wherein the alkyl groups have from 1 to 8 carbon atoms, or ionomers of said copolymers, wherein the weight percentage of copolymerized units of said unsaturated carboxylic acid in said ethylene acid copolymer is from about 3 to about 35 wt. %, based on the weight of said ethylene acid copolymer, and wherein from about 0% to about 90% of the acid is neutralized; and
(iii) at least one additional polymeric layer comprising a copolymer of ethylene and vinyl acetate or a copolymer of ethylene and an alkyl(meth)acrylate.

In some multilayer structures, it may be desirable that the permeable blend composition consists essentially of an ethylene-containing polymer that is the same as that used in the at least one additional layer.

Depending on the thickness and compositions of the individual layers of the multilayer film, such films will have OPVs greater than 8,000 cc-mil/m²-day. Other embodiments will have OPV greater than 10,000 cc-mil/m²-day. Some embodiments will have OPV greater than 15,000 cc-mil/m²-day, alternatively greater than 20,000 cc-mil/m²-day. Certain useful embodiments will have OPV greater than 25,000 cc-mil/m²-day, alternatively greater than 30,000 cc-mil/m²-day or even greater than 35,000 cc-mil/m²-day.

As indicated above, this invention also provides packages and packaged products comprising films and other structures prepared from the compositions of the invention. The packages may comprise films wrapped around the packaged product and optionally comprising other packaging materials. Packages may also be formed of one or more portions of film bonded together, for example by heat sealing. Such packages may be in the form of pouches, packets, vacuum skin packaging and the like. Pouches are formed from film web stock by cutting and heat sealing separate pieces of web stock and/or by a combination of folding and heat sealing with cutting. Tubular films may be formed into pouches by sealing across the lengthwise direction of the tube (transverse seal). Other packages include containers with lidding films prepared from permeable compositions as described herein and flexible packages made by laminating the permeable composition to another webstock to improve characteristics such as stiffness and appearance.

Preferred packages comprise one or more of the preferred or notable films or structures as described herein. Preferred packaged products comprise one or more of the preferred or notable films or structures as described herein.

Although the oxygen permeable compositions described herein are described primarily in the form of films, the compositions can also be provided in other forms, including sheets thicker than typical films, shaped articles, and molded articles. These forms impart the desired oxygen permeability properties to a package just as described for the films.

A film or sheet comprising the oxygen permeable compositions could be further processed by thermoforming into a shaped article. For example, a film or sheet comprising an oxygen permeable composition as described herein could be formed into a shaped piece that could be included in packaging. Thermoformed articles typically have a shape in which a sheet of material forms a concave surface such as a tray, cup, can, bucket, tub, box or bowl. The thermoformed article may also comprise a film with a cup-like depression formed therein. In some cases, the thermoformed film or sheet is shaped to match the shape of the material to be packaged therein. Flexible films when thermoformed as described retain some flexibility in the resulting shaped article. Thicker thermoformed sheets may provide semi-rigid or rigid articles. Thermoformed articles of this invention may be combined with additional elements, such as a generally planar film that serves as a lid sealed to the thermoformed article. It may be desirable that the lidding film also be prepared from an oxygen permeable composition as described herein.

As indicated above, a particular shaped article of this invention is a molded cap or closure. Caps may be compression molded or injection molded. Such caps may be used to close and seal a wide variety of containers for a wide variety of products. Cap sizes may typically range from under 20 mm to 120 mm and bottle and/or jar sizes range from under 2-ounce to 128-ounce capacity. Larger capacity containers such as drums or kegs are also suitable for the practice of the invention as are smaller vials and other containers.

Injection molded hollow articles suitable as bottle preforms are further examples of molded articles of this invention.

Examples of blow molded articles include containers such as blown bottles. For example, in the bottle and container industry, the blow molding of injection molded preforms has gained wide acceptance.

The bottles of this invention are particularly useful for packaging liquids and powders, granules and other flowable solids.

Although containers are generally described herein as bottles, other containers such as vials, jars, drums and fuel tanks may be prepared as described herein from the compositions and articles of this invention.

Another shaped article is a profile. Profiles are defined by having a particular shape and by their process of manufacture known as profile extrusion. Profiles are not film or sheeting, and thus the process for making profiles does not include the use of calendering or chill rolls. Profiles are also not prepared by injection molding processes. Profiles are fabricated by melt extrusion processes that begin by extruding a thermoplastic melt through an orifice of a die forming an extrudate capable of maintaining a desired shape. The extrudate is typically drawn into its final dimensions while maintaining the desired shape and then quenched in air or a water bath to set the shape, thereby producing a profile. In the formation of simple profiles, the extrudate preferably maintains shape without any structural assistance. With extremely complex shapes, support means are often used to assist in shape retention. In either case, the type of thermoplastic resins used and their melt strength during formation is critical. A common shape of a profile is tubing.

In general, those of skill in the art will be aware of techniques for forming the articles of the invention.

The following examples are presented to further illustrate various aspects and features of the present invention. As such, the examples are not meant to be unduly limiting.

### EXAMPLES

### Example 1

A composition is prepared by melt blending 58 weight % of an ethylene methacrylic acid copolymer having 15 weight % copolymerized units of methacrylic acid and having a melt index of 60 g/10 minutes (190° C., 2.16 kg. weight); 14 weight % of an ethylene methyl acrylate copolymer having 24 weight % copolymerized units of methyl acrylate and having a melt index of 20 g/10 minutes (190° C., 2.16 kg. weight); 25 weight % of magnesium stearate; and 3 weight % magnesium hydroxide in an extruder and pelletized. The resulting composition has a melt index of about 0.7 g/10 minutes (190° C., 2.16 kg. weight). Pellets of the composition and concurrently pellets of a polyethylene prepared using metallocene technology are fed into a cast film machine and then melt blended. The feed rates are adjusted so that the resultant blend composition has a concentration of 60 weight % of polyethylene, based on the total weight of the composition. The blend composition is extruded through a slit die and quenched to provide a cast film of 1 mil thickness.

### Example 2

A composition is prepared by melt blending the following components in a twin screw extruder in the proportions stated: 47.10 weight % of an ethylene methacrylic acid isobutyl acrylate copolymer having 10 weight % copolymerized units of methacrylic acid and 10 weight % copolymerized units of isobutyl acrylate (melt index 35 g/10 minutes at 190° C., 2.16 kg. weight); 32.4 weight % of an ethylene methyl acrylate copolymer having 24 weight % copolymerized units of methyl acrylate (melt index 20 g/10 minutes at 190° C., 2.16 kg. weight); 18.05 weight % of magnesium stearate; and 2.45 weight % of a magnesium hydroxide concentrate (50 weight % magnesium hydroxide in an ethylene methacrylic acid copolymer carrier resin). The resultant mixture is pelletized using a strand cutter. 65 kilograms of this composition is mixed in an extruder with 35 kilograms of Engage® 8100 polyethylene, which is a polyethylene prepared using metallocene catalyst technology, to form a composition of the invention.

### Example 3

A composition is prepared by melt blending the following components in a twin screw extruder in the proportions stated: 53.39 weight % of an ethylene methacrylic acid isobutyl acrylate copolymer having 10 weight % copolymerized units of methacrylic acid, and 10 weight % copolymerized units of isobutyl acrylate (melt index 35 g/10 minutes at 190° C., 2.16 kg. weight); 23.05 weight % of an ethylene methyl acrylate copolymer having 24 weight % copolymerized units of methyl acrylate (melt index 20 g/10 minutes at 190° C., 2.16 kg weight); 20.74 weight % of magnesium stearate; and 2.82 weight % of a magnesium hydroxide concentrate (50 weight % magnesium hydroxide in an ethylene methacrylic acid copolymer carrier resin) The resultant mixture is pelletized using a strand cutter. 70 kilograms of this composition is mixed with 30 kilograms of low density polyethylene (melt index 2.0 g/10 minutes at 190° C., 2.16 kg. weight) in an extruder, to form a composition of the invention.

What is claimed is:

1. A composition consisting essentially of:
A. from about 5 to about 60 weight percent, based on the total weight of the composition, of a polyolefin selected from the group consisting of a) ethylene homopolymers, b) copolymers of ethylene and an alpha-olefin having three or more carbon atoms and c) mixtures thereof, wherein said polyolefins are substantially free of carboxylic acid, ester and anhydride groups; and
B. from about 40 to about 95 weight percent, based on the total weight of the composition, of a combination consisting essentially of
1. a polar organic compound component selected from the group consisting of a) aliphatic organic carboxylic acids having fewer than 36 carbon atoms, b) alkaline earth metal salts of said acids and c) mixtures thereof;
2. a polar copolymer component selected from the group consisting of a) ethylene acid copolymers having copolymerized units of ethylene, at least one C₃ to C₈ α,β-ethylenically unsaturated carboxylic acid, and optionally a comonomer selected from the group consisting of alkyl acrylates and alkyl methacrylates, wherein said alkyl groups have from 1 to 8 carbon atoms, b) alkaline earth metal ionomers of said ethylene acid copolymers and c) mixtures thereof, wherein the weight percentage of copolymerized units of said unsaturated carboxylic acid in said ethylene acid copolymer is from about 3 to about 35 wt. %, based on the weight of said ethylene acid copolymer; and
3. at least one ethylene unsaturated ester copolymer having copolymerized units of ethylene and a comonomer selected from the group consisting of vinyl acetate, alkyl acrylates and alkyl methacrylates,
wherein greater than 70% of the total combined carboxylic acid moieties of said polar organic compound component and said polar copolymer component have been neutralized to the corresponding alkaline earth metal carboxylate salts.

2. A composition of claim 1 wherein greater than 80% of the total combined carboxylic acid moieties of said polar organic compound component and said polar copolymer component are neutralized to the corresponding alkaline earth metal salts.

3. A composition of claim 2 wherein greater than 90% of the total combined carboxylic acid moieties of said polar organic compound component and said polar copolymer component are neutralized to the corresponding alkaline earth metal salts.

4. A composition of claim 3 wherein 100% of the total combined carboxylic acid moieties of said polar organic compound component and said polar copolymer component are neutralized to the corresponding alkaline earth metal salts.

5. A composition of claim 1 wherein said polyolefin is an ethylene homopolymer.

6. A composition of claim 1 wherein said polyolefin is a copolymer of ethylene and an alpha-olefin having three or more carbon atoms.

7. A composition of claim 1 wherein said ethylene copolymer is selected from the group consisting of linear low density polyethylenes, ultra low density polyethylenes, very low density polyethylenes, metallocene polyethylenes, ethylene propylene copolymers and copolymers of ethylene, propylene and a diene monomer.

8. A composition of claim 1 wherein said carboxylic acid moieties are neutralized to alkaline earth metal salts and wherein the alkaline earth metal salt is selected from the group consisting of calcium salts and magnesium salts.

9. A composition of claim 1 wherein said aliphatic organic carboxylic acids are acids having from six to twenty-six carbon atoms.

10. A composition of claim 1 wherein said ethylene acid copolymer is selected from the group consisting of ethylene acrylic acid copolymers and ethylene methacrylic acid copolymers.

11. A composition of claim 1 wherein said ethylene acid copolymer is a terpolymer.

12. A composition of claim 11 wherein said ethylene acid copolymer is selected from the group consisting of ethylene/(meth)acrylic acid/n-butyl (meth)acrylate terpolymers, ethylene/(meth)acrylic acid/iso-butyl (meth)acrylate terpolymers, ethylene/(meth)acrylic acid/methyl(meth)acrylate terpolymers and ethylene/(meth)acrylic acid/ethyl(meth)acrylate terpolymers.

13. A composition of claim 1 wherein said ethylene unsaturated ester copolymer is a copolymer having copolymerized units of ethylene and vinyl acetate.

14. A composition of claim 1 wherein said ethylene unsaturated ester copolymer is a copolymer selected from the group consisting of copolymers having copolymerized units of ethylene and an alkyl acrylate and copolymers having copolymerized units of ethylene and an alkyl methacrylate.

15. A composition of claim 1 wherein said at least one ethylene unsaturated ester copolymer is a mixture of an ethylene vinyl acetate copolymer and at least one copolymer selected from the group consisting of copolymers of ethylene and an alkyl acrylate and copolymers of ethylene and an alkyl methacrylate.

16. A film consisting essentially of a composition of claim 1.

17. A multilayer structure wherein one layer consists essentially of a composition of claim 1.

18. A multilayer structure of claim 17 wherein at least one layer is a film consisting essentially of a composition of claim 1.

19. A multilayer structure of claim 17 comprising at least one inner layer and two outer layers wherein the outer layers consist essentially of a composition of claim 7 wherein the ethylene copolymer is a metallocene polyolefin.

20. A multilayer structure of claim 17 comprising at least one layer consisting essentially of a composition of claim 7 wherein the ethylene copolymer is a linear low density polyethylene.

21. A multilayer structure of claim 17 wherein a second layer comprises a polymer selected from the group consisting of ethylene vinyl acetate copolymers; low density polyethylenes; linear low density polyethylenes; ultra low density polyethylenes; very low density polyethylenes; metallocene polyethylenes; ethylene acid copolymers having copolymerized units of ethylene, at least one C₃ to C₈ α,β-ethylenically unsaturated carboxylic acid and optionally a comonomer selected from the group consisting of alkyl acrylates and alkyl methacrylates, wherein said alkyl groups have from 1 to 8 carbon atoms; alkaline earth metal ionomers of said ethylene acid copolymers and mixtures thereof.

22. A sheet consisting essentially of a composition of claim 1.

23. A package comprising a film consisting essentially of a composition of claim 1.

24. A monolithic structure consisting essentially of a composition of claim 1.

25. A shaped article comprising a composition of claim 1.

26. A shaped article of claim 25 selected from the group consisting of caps, cups, bowls, buckets, kegs, tubs, trays, vials, bottles and drums.

27. A package comprising a multilayer structure wherein at least one layer consists essentially of a composition of claim 1.

28. A profile comprising a composition of claim 1.

29. A package selected from the group consisting of pouches, packets and skin packages comprising a composition of claim 1.

30. A composition consisting essentially of:
A. from about 5 to about 60 weight percent, based on the total weight of the composition, of a) a polyolefin selected from the group consisting of ethylene homopolymers, b) copolymers of ethylene and an alpha-olefin having three or more carbon atoms and c) mixtures thereof, wherein said polyolefins are substantially free of carboxylic acid, ester and anhydride groups; and
B. from about 40 to about 95 weight percent, based on the total weight of the composition, of a combination consisting essentially of
1. a polar organic compound component selected from the group consisting of a) aliphatic organic carboxylic acids having fewer than 36 carbon atoms, b) alkaline earth metal salts of said acids and c) mixtures thereof;
2. a polar copolymer component selected from the group consisting of a) ethylene acid copolymers having copolymerized units of ethylene, at least one C₃ to C₈ α,β-ethylenically unsaturated carboxylic acid, and optionally a comonomer selected from the group consisting of alkyl acrylates and alkyl methacrylates, wherein said alkyl groups have from 1 to 8 carbon atoms, b) alkaline earth metal ionomers of said ethylene acid copolymers and c) mixtures thereof, wherein the weight percentage of copolymerized units of said unsaturated carboxylic acid in said ethylene acid copolymer is from about 3 to about 35 wt. %, based on the weight of said ethylene acid copolymer;
3. an ionic compound selected from the group consisting of compounds having cations selected from the group consisting of calcium cations and magnesium cations, and
4. at least one ethylene unsaturated ester copolymer having copolymerized units of ethylene and a comonomer selected from the group consisting of vinyl acetate, alkyl acrylates and alkyl methacrylates,
said ionic compound being present in an amount such that the stoichiometric amount of cations present in said composition is sufficient to neutralize greater than 70% of the total combined carboxylic acid moieties of said polar organic compound component and said polar copolymer component.

31. A composition of claim 30 wherein the ionic compound is selected from the group consisting of calcium oxide, calcium hydroxide, magnesium oxide and magnesium hydroxide and mixtures thereof.
